(19) United States
(12) Patent Application Publication
(10) Pub. No.: US 2026/0143555 A1
(43) Pub. Date: May 21, 2026

(54) AIML - UE SUGGESTED CONNECTION REMAINING TIME

(71) Applicant: Mediatek Inc., Hsinchu (TW)

(72) Inventors: Ren-Huang Liu, Hsinchu (TW); Kuo-Chun Lee, San Jose, CA (US)

(21) Appl. No.: 19/371,143

(22) Filed: Oct. 28, 2025

Related U.S. Application Data
(60) Provisional application No. 63/721,660, filed on Nov. 18, 2024.

(51) Int. Cl. H04W 76/27

(52) U.S. Cl. CPC H04W 76/27

(57) ABSTRACT

In an aspect of the disclosure, a method, a computer-readable medium, and an apparatus are provided. The apparatus may be a UE. The UE determines a connection remaining time based on its internal status during a Radio Resource Control (RRC) connected mode. The connection remaining time may indicate a suggested duration for maintaining an RRC connection. The UE transmits an uplink RRC message to a base station. The message may include the connection remaining time to enable the base station to adjust an RRC inactivity timer associated with the RRC connection.

### CROSS-REFERENCE TO RELATED APPLICATION(S)

This application claims the benefits of U.S. Provisional Application Ser. No. 63/721,660, entitled “AIML—UE Suggested Connection Remaining Time” and filed on Nov. 18, 2024, which is expressly incorporated by reference herein in its entirety.

### BACKGROUND

### Field

The present disclosure relates generally to wireless communications, and more particularly, to techniques of UE suggested connection remaining time.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE determines a connection remaining time based on its internal status during a Radio Resource Control (RRC) connected mode. The connection remaining time may indicate a suggested duration for maintaining an RRC connection. The UE transmits an uplink RRC message to a base station. The message may include the connection remaining time to enable the base station to adjust an RRC inactivity timer associated with the RRC connection.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram illustrating a mechanism for adjusting an RRC inactivity timer during an RRC connection.

FIG. 6 illustrates a flow chart of a process for UE suggested connection remaining time.

FIG. 7 illustrates a flow chart of another process for UE suggested connection remaining time.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

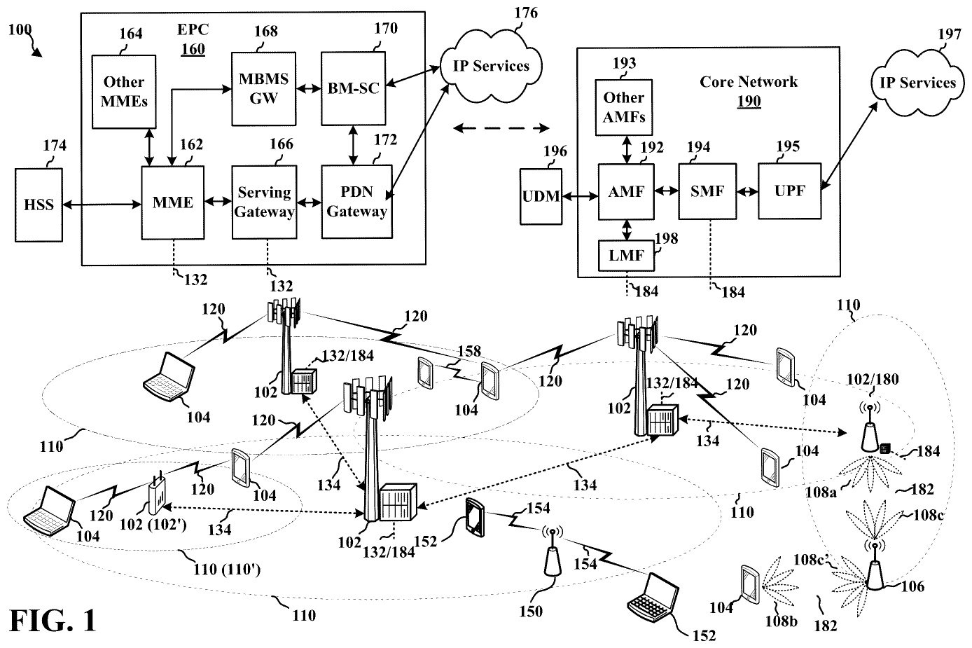

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

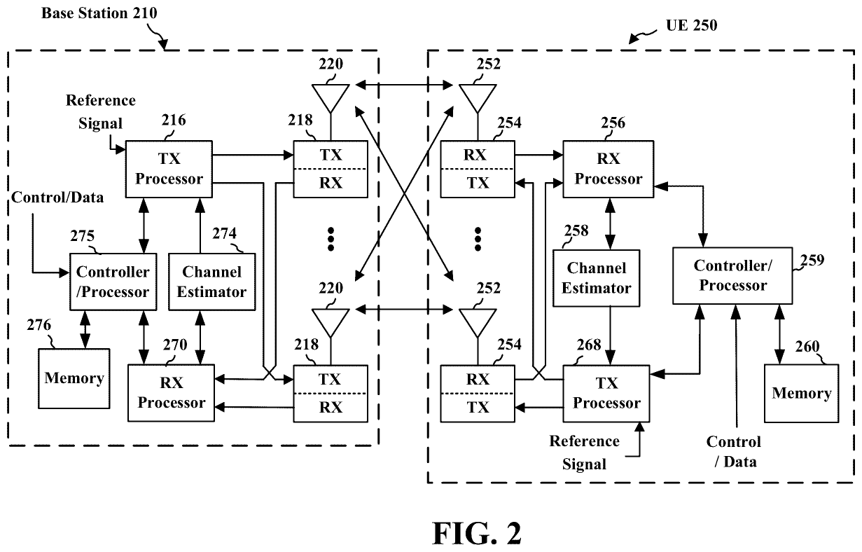

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

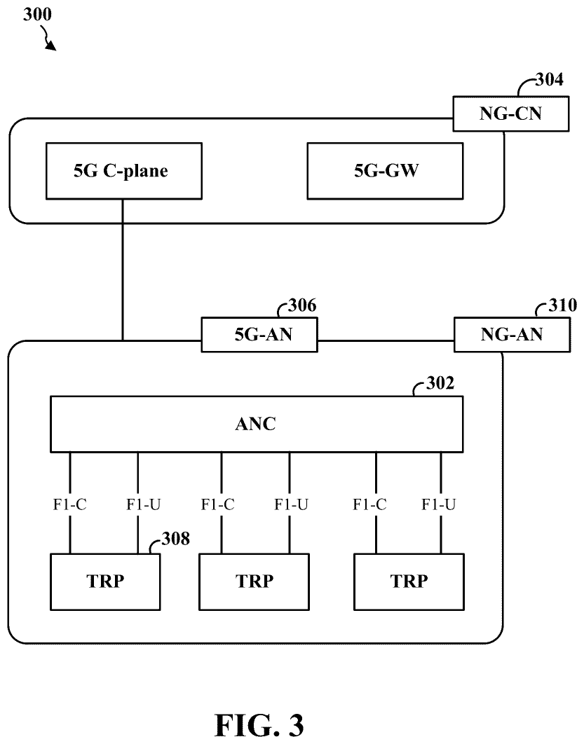

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

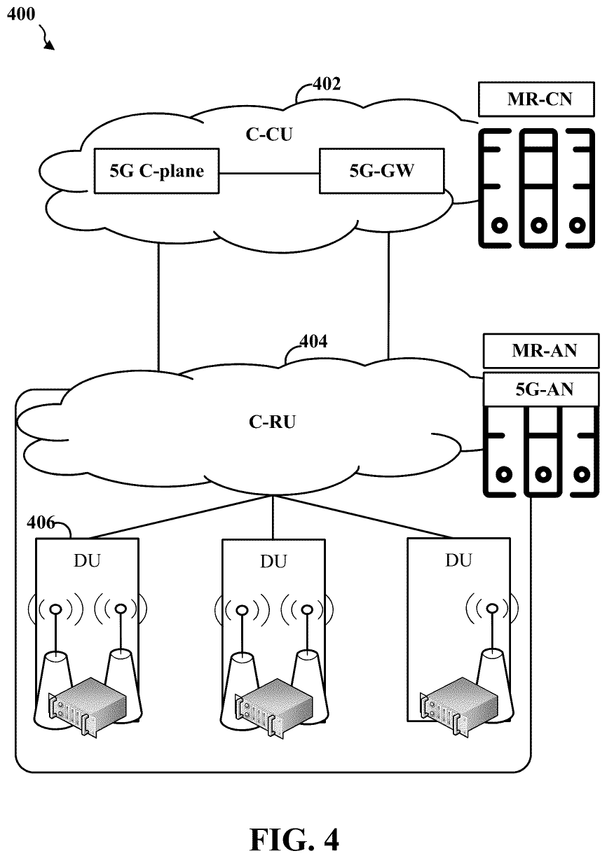

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

Radio Resource Control (RRC) is a protocol layer in wireless communication networks, such as 4G LTE and 5G NR, that manages radio resources and the connection state between a UE and a base station. A UE operates in one of two primary states: RRC Idle or RRC Connected. The management of transitions between these states is a fundamental aspect of balancing network resource efficiency with UE power consumption.

The RRC Idle mode is a power-saving state that the UE enters when it has no active data to transmit or receive. In this state, the UE does not maintain a continuous signaling connection with the base station and does not occupy dedicated radio resources. The network tracks the UE's location at a broader Tracking Area (TA) level, which consists of multiple cells. Due to the low power consumption, this state is suitable for standby scenarios, but the UE must transition to the Connected mode before it can transmit or receive user data.

In contrast, the RRC Connected mode is an active state for service execution, entered when the UE needs to transmit or receive data or signaling. In this mode, the UE establishes and maintains a stable RRC connection with the base station, which allocates dedicated signaling and data resources to the UE. The network tracks the UE's location at the specific cell level, enabling direct uplink (UL) and downlink (DL) data transmission. While this state supports active services, it consumes more power as the UE must continuously maintain the connection and respond to resource scheduling from the network.

When the UE enters the RRC Connected mode, the base station starts an RRC inactivity timer, which typically has a duration of 10 seconds. This timer is maintained by the base station to monitor the activity status of the RRC connection. The timer is reset whenever there is uplink or downlink signal or data transmission associated with the RRC connection. If no activity occurs for the entire duration of the timer, meaning the UE does not send or receive any signals or data during this period, the timer expires. Upon expiration, the base station sends an RRC Connection Release message to the UE, causing the UE to release its dedicated resources and return to the RRC Idle mode. This mechanism allows the network to reclaim radio resources from inactive connections and helps the UE conserve battery power by returning to the low-power Idle state when the connection is no longer needed.

Currently, the value of the RRC inactivity timer is configured as a fixed duration, typically set to 10 seconds. This timer serves to maintain the RRC connection for a predefined period after the last data transmission, anticipating potential subsequent transmissions and avoiding the overhead of frequent connection re-establishments. However, this one-size-fits-all approach may not be optimal for the diverse range of user traffic patterns and service types encountered in modern wireless networks.

The inefficiency of the fixed timer becomes particularly apparent when considering short-duration transactions. For instance, when an RRC connection is established specifically to transmit a Short Message Service (SMS) message, the actual data transmission typically completes within approximately one second. Despite the completion of the intended transmission, the UE must remain in the RRC Connected state for the entire duration of the 10-second inactivity timer before the base station initiates the connection release procedure. During this waiting period, no actual data transmission occurs, yet the UE continues to consume power maintaining the active connection state, monitoring control channels, and performing measurements required in the Connected mode.

This inefficiency extends beyond simple messaging services to various other traffic types that have distinct transmission patterns and duration requirements. The fixed timer value represents a compromise that may be too long for brief transactions, resulting in wasted power consumption and unnecessarily occupied radio resources, or potentially too short for applications with intermittent data patterns, which could lead to premature connection releases and subsequent re-establishment overhead. The inability to adapt the timer duration to match the actual traffic characteristics and service requirements creates a fundamental mismatch between the connection management mechanism and the diverse operational scenarios encountered in practical deployments.

To address the inefficiency of a fixed Radio Resource Control (RRC) inactivity timer, a mechanism is proposed where the UE can suggest a connection remaining time to the base station. The RRC inactivity timer is maintained by the base station to monitor the activity status of RRC connections. When this timer expires without any uplink or downlink activity, the base station releases the RRC connection. By allowing the UE to provide input on the desired connection duration, the base station can adjust its timer more appropriately, enabling the UE to transition to RRC Idle mode sooner when appropriate. This mechanism conserves both UE battery power and network radio resources.

The UE determines a connection remaining time based on its internal status and operational context. This determination may rely on various factors including the screen state (on or off), the type of data traffic being handled, and the characteristics of currently running applications. For a single-factor approach, if the determining factor is a running application such as a background file download, the UE can calculate the remaining time based on the remaining data size and current transmission rate. When using multiple factors, the UE applies specific weightings or priorities to these factors. For example, service type from running applications may take precedence over screen state, such that a video streaming application would result in an extended connection remaining time to match the estimated stream duration, regardless of whether the screen is turned off.

The UE may dynamically update its calculation of connection remaining time. When detecting significant state changes such as service type switching, screen state transitions, or changes in the number of active applications, the UE re-calculates the remaining time and may trigger a new report to the base station. The connection remaining time value may be constrained within a specified range, such as from 1 second to 5 seconds, to maintain practical bounds on the suggested duration.

The UE communicates the calculated connection remaining time to the base station through an RRC message, such as the UE Assistance Information message. This value can be transmitted using reserved fields within the message structure. For instance, a 16-bit field with millisecond units can accommodate values ranging from 1000 ms to 5000 ms. The UE initially reports the connection remaining time when the RRC connection is established, and subsequently provides updates either periodically or aperiodically. Periodic updates might occur every 60 seconds while the UE remains in RRC Connected state. Aperiodic updates are triggered when the newly calculated remaining time deviates from the previously reported value by more than a threshold, such as a 20% change.

Upon receiving the connection remaining time from the UE, the base station adjusts its RRC inactivity timer to optimize connection management and radio resource utilization. The base station does not directly adopt the UE-suggested value but rather uses it as an input to its adjustment algorithm. For example, if the UE indicates a 2-second connection remaining time, the base station might adjust its default 10-second timer to 5 seconds rather than directly setting it to 2 seconds.

The adjustment of the RRC inactivity timer follows a formula that balances the UE's suggestion with the base station's operational requirements:
adjusted_rrc_inactivity_timer=min{connection_remaining_time+X, rrc_inactivity_timer},
   where connection_remaining_time is the value suggested by the UE, rrc_inactivity_timer is the base station's current or default timer value, and X is an additional offset determined by the base station. This formula takes the minimum between the base station's original timer value and the sum of the UE's suggested time plus the offset, preventing the adjusted timer from exceeding the original configuration.

The offset value X represents the base station's adjustment to the UE-suggested time and serves as a buffer to account for network-side considerations. This offset can be configured as a fixed constant, such as 3 seconds, or can be dynamically determined based on various network factors. The offset may be initially set when the RRC connection is established and subsequently updated whenever the UE reports a new connection remaining time.

The base station determines the offset value by evaluating multiple operational factors. Radio resource efficiency is a primary consideration, where shorter timers allow quicker release of radio resources when connections are truly idle, improving overall system efficiency. However, this must be balanced against signaling load considerations. If the timer is set too short and data transmission resumes shortly after connection release, the resulting RRC re-establishment procedures generate additional signaling overhead, potentially degrading system performance.

The base station also considers observed traffic patterns of the UE. By analyzing the UE's historical data transmission behavior, the base station can predict the likelihood of near-term data transmission needs. If the base station anticipates that the UE will likely transmit or receive data soon, it may configure a larger offset value to maintain the connection longer. Additionally, the base station's current load status influences the offset configuration. During periods of high congestion or heavy load, the base station may reduce the offset to release connections more aggressively and free up resources for other users.

These factors can be applied individually or in combination to determine the offset value. For individual factor consideration, the base station might establish discrete levels for the offset, such as five levels ranging from 1 second to 5 seconds. When considering traffic patterns, the base station could map different probabilities of imminent data transmission to specific offset values. For instance, a 0-20% probability of near-term data needs might correspond to a 1-second offset, while an 81-100% probability might result in a 5-second offset.

When multiple factors are combined, the base station assigns weights to each factor based on their relative importance in the current network context. For example, if the base station's load status is assigned a weight of 0.7 and radio resource efficiency a weight of 0.3, with corresponding calculated offset values of 3 seconds and 4 seconds respectively, the combined offset would be calculated as (0.7×3)+(0.3×4)=3.3 seconds, which could be rounded to 3 seconds for practical implementation.

After determining the adjusted RRC inactivity timer value, the base station starts this timer when detecting inactivity on the connection, specifically when there is no uplink or downlink signal or data transmission. If the timer expires without any activity, the base station initiates connection release by sending an RRC Release message to the UE, causing the UE to transition to RRC Idle mode. However, if downlink data for the UE arrives before the timer expires, the base station cancels the timer and maintains the RRC connection to facilitate the data transmission. This timer cancellation mechanism prevents unnecessary connection releases when data transmission resumes within the adjusted timeout period.

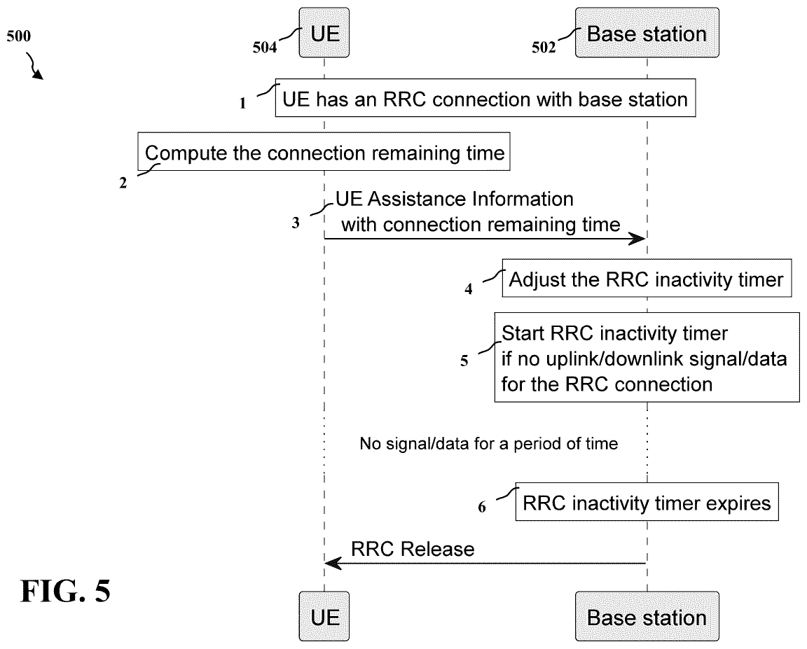

FIG. 5 is a sequence diagram 500 illustrating a procedure for dynamic adjustment of a Radio Resource Control (RRC) inactivity timer based on User Equipment (UE) input. The procedure involves communication between a UE 504 and a base station 502 to optimize connection management and resource utilization.

The procedure begins at step 1 with an established RRC connection between the UE 504 and the base station 502. This represents the initial state where the UE is in RRC Connected mode and actively maintains radio resources with the network. At step 2, the UE 504 computes a connection remaining time based on its current operational context. This computation takes into account various factors available to the UE, including the screen state (whether the display is on or off), the type of traffic currently being transmitted or expected to be transmitted, and the characteristics of applications running on the device. For example, if the UE is transmitting a short message service (SMS) message, it may determine that only a brief connection duration is needed, whereas a video streaming application would require a longer connection time.

At step 3, the UE 504 transmits the computed connection remaining time to the base station 502 using an RRC message, specifically the UE Assistance Information message or another dedicated uplink RRC message. This message carries the UE's suggestion for how long the connection should remain active based on its current needs. The connection remaining time represents the UE's estimation of the duration for which it expects to need the RRC connection, allowing the network to make more informed decisions about resource management.

Upon receiving the UE Assistance Information message, the base station 502 at step 4 adjusts its RRC inactivity timer. The base station does not simply adopt the UE-suggested value directly but rather uses it as an input to determine an appropriate timer value that balances the UE's needs with network resource management requirements. The adjustment algorithm considers both the UE's suggestion and the base station's own operational constraints, potentially applying an offset or using a formula to calculate the final timer value. For instance, if the UE suggests a 2-second remaining time, the base station might adjust its standard 10-second inactivity timer to 5 seconds rather than directly setting it to 2 seconds.

At step 5, the base station 502 monitors the RRC connection for activity. When no uplink or downlink signals or data are transmitted on the connection, indicating that the connection has become inactive, the base station starts the adjusted RRC inactivity timer. The timer continues to run as long as the connection remains inactive. If any uplink or downlink activity occurs before the timer expires, the base station would reset or cancel the timer and maintain the connection. However, if the connection remains inactive for the entire duration of the adjusted timer, the procedure continues to step 6.

At step 6, when the adjusted RRC inactivity timer expires without any intervening activity, the base station 502 sends an RRC Release message to the UE 504. This message instructs the UE to release its dedicated radio resources and transition from RRC Connected mode to RRC Idle mode. The release of the connection allows the UE to enter a power-saving state more quickly than it would have with a fixed timer value, while also freeing up radio resources on the network side for allocation to other users.

This mechanism provides a flexible approach to connection management that adapts to the actual needs of different services and traffic patterns. By allowing the UE to provide input about its expected connection duration, the system can avoid maintaining unnecessary connections for extended periods after short transactions are complete, while still maintaining connections appropriately for services that require them. The result is improved power efficiency for the UE and more efficient utilization of radio resources in the network.

The base station's determination of the adjusted RRC inactivity timer involves consideration of multiple interrelated factors that impact both network performance and resource utilization. While the UE's suggested connection remaining time serves as a key input, the base station does not necessarily adopt this value directly. Instead, the base station uses it as input to an internal algorithm that balances the UE's immediate needs with broader network performance and efficiency goals. The base station evaluates several operational factors to determine an appropriate offset value to be applied to the UE's suggested time, ultimately calculating the final adjusted timer value.

Radio resource efficiency represents a consideration in timer adjustment. When the RRC inactivity timer is configured with a longer duration, the UE retains its allocated radio resources for an extended period even when no active data transmission occurs. These dedicated resources, including control channel elements, uplink grants, and downlink scheduling assignments, remain reserved but unutilized during idle periods. By configuring a shorter timer value, the base station can reclaim these resources more quickly, making them available for allocation to other users who have active data transmission needs. This approach improves the overall spectral efficiency of the cell and increases the number of users that can be served simultaneously, which is especially critical in densely populated areas. However, the pursuit of maximum resource efficiency through aggressive timer reduction must be tempered by consideration of other operational factors that may introduce different types of overhead.

Signaling load considerations create a counterbalancing force against the drive for shorter timers. When the RRC inactivity timer expires and the base station releases the connection, the UE transitions to RRC Idle mode and releases all dedicated resources. If shortly after this release the UE or the network needs to transmit data again, a complete RRC connection re-establishment procedure must be executed. This re-establishment process involves multiple message exchanges, including the RRC Connection Request from the UE, RRC Connection Setup from the base station, and RRC Connection Setup Complete from the UE. Additional signaling includes authentication and security procedures, bearer establishment, and context updates with the core network. Each re-establishment cycle consumes processing resources at both the UE and base station, occupies signaling radio bearers, and introduces latency before actual data transmission can resume. If the timer is set too aggressively short, the system may enter a pattern of frequent connection releases followed by rapid re-establishments, generating substantial signaling overhead that can actually degrade overall system performance. The cumulative effect of excessive signaling can strain both the air interface and the base station's processing capacity, potentially impacting service quality for all users. Therefore, the base station must configure the timer to avoid unnecessarily premature releases that would trigger frequent re-establishment procedures. This detrimental side effect can negate the initial gains from quick resource release.

Traffic pattern analysis provides the base station with predictive capabilities for making more informed timer adjustment decisions. By observing and analyzing the UE's historical data transmission behavior over time, the base station can identify characteristic patterns associated with different service types and usage scenarios. For instance, a web browsing session typically exhibits a bursty pattern with short periods of intense downlink data transfer followed by reading intervals where the user consumes the displayed content without generating network traffic. During these reading intervals, which may last several seconds to minutes, another burst of downlink data can be anticipated when the user navigates to the next page. Similarly, instant messaging applications often show patterns of message exchanges where replies arrive within predictable timeframes, and applications with periodic keep-alive messages demonstrate regular activity intervals. By recognizing these patterns and examining the inter-arrival times of data packets or sessions, the base station can build a predictive model and estimate the probability that additional data transmission will occur within a given timeframe. If the observed traffic pattern indicates a high likelihood of imminent data transmission, such as during an active web browsing session with frequent page loads or applications with bursty but frequent data exchanges, the base station can configure a larger offset value to extend the adjusted inactivity timer. This proactive approach maintains the connection through predicted idle periods, avoiding the overhead of connection re-establishment when activity resumes. Conversely, if the traffic pattern suggests that the current transaction represents a final or isolated transmission, such as the completion of a file download or the transmission of a single SMS message, the base station can apply a smaller offset to enable quicker connection release. The base station may implement pattern recognition algorithms that categorize observed behaviors into defined traffic models, with each model associated with specific timer adjustment parameters.

The base station's current loading status introduces dynamic adaptation based on real-time network conditions and represents a critical factor in the decision-making process. The loading status encompasses multiple dimensions of network resource utilization, including the number of active RRC connections currently maintained, the percentage of available physical resource blocks allocated for scheduled transmissions, processing load on the base station's computational resources, and backhaul capacity utilization. During periods of heavy congestion when the base station approaches or reaches its capacity limits, maintaining inactive connections represents a significant opportunity cost, as those resources could be immediately utilized by users with active data transmission needs. When the base station is experiencing high load or congestion, its priority shifts towards maximizing resource availability for all users. Under these conditions, the base station may adopt a more aggressive connection release strategy by reducing the offset value, thereby shortening the adjusted inactivity timer and favoring shorter inactivity timers to reclaim resources from inactive UEs as rapidly as possible. This adaptation helps to free up scarce resources more quickly, alleviates congestion, reduces the blocking probability for new connection requests, and improves the quality of service for active users. The base station may define multiple load threshold levels, each associated with a specific offset adjustment policy. For example, when the system load exceeds eighty percent of capacity, the base station might reduce all offset values by a fixed amount or apply a scaling factor to compress the timer durations. Conversely, during periods of light load when ample resources are available, the base station can afford to be more lenient, maintaining connections for longer durations with minimal adverse impact and potentially increasing offset values to minimize signaling overhead from re-establishments and provide a more stable connection experience for individual UEs. This load-adaptive behavior enables the network to dynamically balance resource efficiency against signaling overhead based on current operating conditions, optimizing overall system performance across varying traffic demands.

The base station may apply these factors individually or in combination to determine the final offset value and resulting adjusted timer. When applying factors individually, the base station selects the single most relevant factor based on current circumstances and determines the offset accordingly. For example, if the base station is experiencing critical overload conditions, the loading status factor may take precedence, overriding other considerations to prioritize immediate resource reclamation. Alternatively, when combining multiple factors, the base station employs a weighted aggregation approach where each factor contributes to the final offset value according to its assigned importance weight. The weights themselves may be statically configured based on operator policies or dynamically adjusted based on network conditions and performance metrics. For instance, during peak traffic hours, the loading status factor might receive increased weighting, while during off-peak periods, signaling load considerations might receive higher priority to minimize unnecessary connection cycling. The mathematical combination of weighted factors allows the base station to synthesize a balanced offset value that reflects the multidimensional optimization objectives inherent in connection management.

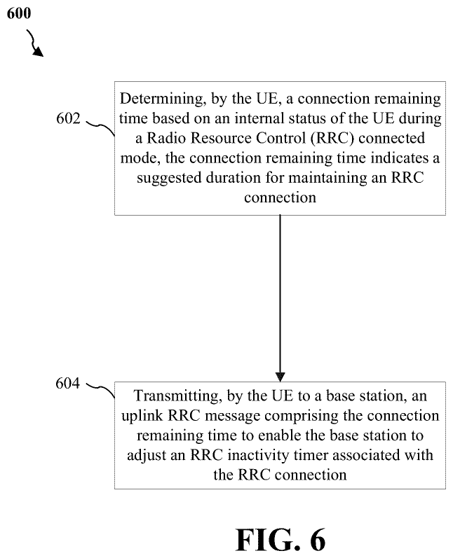

FIG. 6 illustrates a flow chart 600 of a process for UE suggested connection remaining time. This process involves interactions between a network (NW) and a UE (e.g., the UE 104) through a base station (e.g., the base station 102).

At block 602, the UE determines a connection remaining time based on its internal status during a Radio Resource Control (RRC) connected mode. The connection remaining time may indicate a suggested duration for maintaining an RRC connection.

At block 604, the UE transmits an uplink RRC message to a base station. The message may include the connection remaining time to enable the base station to adjust an RRC inactivity timer associated with the RRC connection.

In certain configurations, the internal status of the UE may include at least one of: a screen on or off state, a traffic type of data being handled, or characteristics of a running application.

In certain configurations, determining the connection remaining time may include applying predefined weightings or priorities to a plurality of internal status factors.

In certain configurations, the uplink RRC message may be a UE Assistance Information message.

In certain configurations, the UE may further: detect a change in its internal status; re-calculate the connection remaining time in response to the detected change; and transmit an updated connection remaining time to the base station in a subsequent uplink RRC message.

In certain configurations, transmitting the updated connection remaining time may be performed: periodically at predetermined intervals while in the RRC connected mode; or aperiodically in response to the re-calculated connection remaining time deviating from a previously transmitted value by more than a predefined threshold.

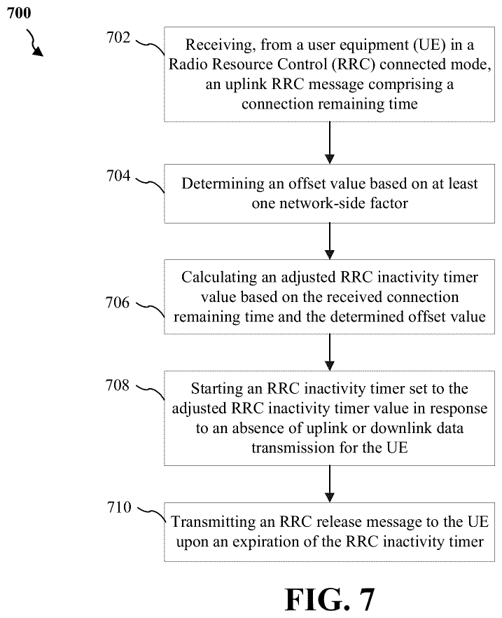

FIG. 7 illustrates a flow chart 700 of another process for UE suggested connection remaining time. This process involves interactions between a network (NW) and a UE (e.g., the UE 104) through a base station (e.g., the base station 102).

At block 702, the base station receives, from a user equipment (UE) in a Radio Resource Control (RRC) connected mode, an uplink RRC message including a connection remaining time.

At block 704, the base station determines an offset value based on at least one network-side factor.

At block 706, the base station calculates an adjusted RRC inactivity timer value based on the received connection remaining time and the determined offset value.

At block 708, the base station starts an RRC inactivity timer set to the adjusted RRC inactivity timer value in response to an absence of uplink or downlink data transmission for the UE.

At block 710, the base station transmitting an RRC release message to the UE upon an expiration of the RRC inactivity timer.

In certain configurations, the at least one network-side factor may include at least one of: radio resource efficiency, signaling load associated with RRC connection re-establishments, an observed traffic pattern of the UE, or a current load status of the base station.

In certain configurations, determining the offset value based on the current load status of the base station may include decreasing the offset value when the current load status exceeds a load threshold to accelerate resource reclamation.

In certain configurations, determining the offset value based on the observed traffic pattern of the UE may include: analyzing historical data transmission behavior of the UE to estimate a probability of subsequent data transmission; and setting the offset value to be larger in response to the estimated probability exceeding a threshold.

In certain configurations, calculating the adjusted RRC inactivity timer value may include determining the adjusted RRC inactivity timer value as a minimum of: (i) a sum of the connection remaining time and the offset value, and (ii) a pre-configured RRC inactivity timer value.

In certain configurations, the offset value may be a pre-configured constant or may be dynamically determined based on the at least one network-side factor.

In certain configurations, determining the offset value may include: assigning a respective weight to each of a plurality of network-side factors; calculating a respective individual offset value for each of the plurality of network-side factors; and calculating the offset value as a weighted combination of the individual offset values based on the assigned weights.

In certain configurations, the weights may be dynamically adjusted based on current network conditions or operator policies.

In certain configurations, the uplink RRC message may be a UE Assistance Information message.

In certain configurations, the base station may further: receive an updated connection remaining time from the UE; re-determine the offset value based on current network-side factors; and re-calculate the adjusted RRC inactivity timer value based on the updated connection remaining time and the re-determined offset value.

In certain configurations, the base station may further: cancel the RRC inactivity timer in response to an arrival of downlink data for the UE prior to the expiration of the RRC inactivity timer.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication performed by a user equipment (UE), the method comprising:
determining, by the UE, a connection remaining time based on an internal status of the UE during a Radio Resource Control (RRC) connected mode, wherein the connection remaining time indicates a suggested duration for maintaining an RRC connection; and
transmitting, by the UE to a base station, an uplink RRC message comprising the connection remaining time to enable the base station to adjust an RRC inactivity timer associated with the RRC connection.

2. The method of claim 1, wherein the internal status of the UE comprises at least one of: a screen on or off state, a traffic type of data being handled, or characteristics of a running application.

3. The method of claim 2, wherein determining the connection remaining time comprises applying predefined weightings or priorities to a plurality of internal status factors.

4. The method of claim 1, wherein the uplink RRC message is a UE Assistance Information message.

5. The method of claim 1, further comprising:
detecting a change in the internal status of the UE;
re-calculating the connection remaining time in response to the detected change; and
transmitting an updated connection remaining time to the base station in a subsequent uplink RRC message.

6. The method of claim 5, wherein transmitting the updated connection remaining time is performed:
periodically at predetermined intervals while in the RRC connected mode; or
aperiodically in response to the re-calculated connection remaining time deviating from a previously transmitted value by more than a predefined threshold.

7. A method of wireless communication performed by a base station, the method comprising:
receiving, from a user equipment (UE) in a Radio Resource Control (RRC) connected mode, an uplink RRC message comprising a connection remaining time;
determining an offset value based on at least one network-side factor;
calculating an adjusted RRC inactivity timer value based on the received connection remaining time and the determined offset value;
starting an RRC inactivity timer set to the adjusted RRC inactivity timer value in response to an absence of uplink or downlink data transmission for the UE; and
transmitting an RRC release message to the UE upon an expiration of the RRC inactivity timer.

8. The method of claim 7, wherein the at least one network-side factor comprises at least one of: radio resource efficiency, signaling load associated with RRC connection re-establishments, an observed traffic pattern of the UE, or a current load status of the base station.

9. The method of claim 8, wherein determining the offset value based on the current load status of the base station comprises decreasing the offset value when the current load status exceeds a load threshold to accelerate resource reclamation.

10. The method of claim 8, wherein determining the offset value based on the observed traffic pattern of the UE comprises:
analyzing historical data transmission behavior of the UE to estimate a probability of subsequent data transmission; and
setting the offset value to be larger in response to the estimated probability exceeding a threshold.

11. The method of claim 7, wherein calculating the adjusted RRC inactivity timer value comprises determining the adjusted RRC inactivity timer value as a minimum of: (i) a sum of the connection remaining time and the offset value, and (ii) a pre-configured RRC inactivity timer value.

12. The method of claim 7, wherein the offset value is a pre-configured constant or is dynamically determined based on the at least one network-side factor.

13. The method of claim 8, wherein determining the offset value comprises:
assigning a respective weight to each of a plurality of network-side factors;
calculating a respective individual offset value for each of the plurality of network-side factors; and
calculating the offset value as a weighted combination of the individual offset values based on the assigned weights.

14. The method of claim 13, wherein the weights are dynamically adjusted based on current network conditions or operator policies.

15. The method of claim 7, wherein the uplink RRC message is a UE Assistance Information message.

16. The method of claim 7, further comprising:
receiving an updated connection remaining time from the UE;
re-determining the offset value based on current network-side factors; and
re-calculating the adjusted RRC inactivity timer value based on the updated connection remaining time and the re-determined offset value.

17. The method of claim 7, further comprising:
canceling the RRC inactivity timer in response to an arrival of downlink data for the UE prior to the expiration of the RRC inactivity timer.

18. An apparatus for wireless communication, the apparatus being a user equipment (UE), comprising:
a memory; and
at least one processor coupled to the memory and configured to:
determine, by the UE, a connection remaining time based on an internal status of the UE during a Radio Resource Control (RRC) connected mode, wherein the connection remaining time indicates a suggested duration for maintaining an RRC connection; and
transmit, by the UE to a base station, an uplink RRC message comprising the connection remaining time to enable the base station to adjust an RRC inactivity timer associated with the RRC connection.

19. The apparatus of claim 18, wherein the internal status of the UE comprises at least one of: a screen on or off state, a traffic type of data being handled, or characteristics of a running application.

20. The apparatus of claim 19, wherein determining the connection remaining time comprises applying predefined weightings or priorities to a plurality of internal status factors.
